(19) United States
(12) Patent Application Publication
(10) Pub. No.: US 2009/0104490 A1
(43) Pub. Date: Apr. 23, 2009

(54) FUEL CELL SYSTEM AND INITIAL DRIVING METHOD THEREOF

(76) Inventors: Seung-Shik Shin, Suwon-si (KR); Ho-Jin Kweon, Suwon-si (KR); Mee-Young Lee, Suwon-si (KR)

Correspondence Address: CHRISTIE, PARKER & HALE, LLP, PO BOX 7068, PASADENA, CA, 91109-7068, US

(21) Appl. No.: 12/176,153

(22) Filed: Jul. 18, 2008

(30) Foreign Application Priority Data
Oct. 18, 2007 (KR) 10-2007-0105084

(51) Int. Cl. H01M 8/04; H01M 8/00

(52) U.S. Cl. 429/23; 429/13

(57) ABSTRACT

A fuel cell system is provided including a fuel cell stack and a starting controller. The fuel cell stack has output terminals for applying an output voltage. The starting controller is configured to control the output voltage applied across the output terminals of the fuel cell stack during a starting period to be a starting voltage lower than a rated voltage.

### CROSS-REFERENCE TO RELATED APPLICATIONS

This application claims priority to and the benefit of Korean Patent Application No. 10-2007-0105084 filed on Oct. 18, 2007, in the Korean Intellectual Property Office, the entire content of which is incorporated herein by reference.

### BACKGROUND

1. Field of the Invention

The present invention relates to a fuel cell system, and more particularly, to an air breathing fuel cell system in which ambient air is supplied to a cathode, and to an initial driving method of the fuel cell system.

2. Discussion of Related Art

An air breathing fuel cell is a fuel cell in which ambient air in the atmosphere is supplied to a cathode by natural convection. A fuel cell stack of a fuel cell can be manufactured in a small size to be suitable for a power source of a portable electric apparatus.

Since the cathode of a fuel cell stack manufactured in an air breathing fuel cell is exposed to the atmosphere, if the fuel cell is not used for a long time, the membrane of the fuel cell stack can become dehydrated. If the membrane is dehydrated, it can take a long time for the operation of the fuel cell stack to be stabilized and can even take up to fifteen minutes or more. Therefore, there is a need to improve the performance of the air breathing fuel cell stack with respect to the membrane of the fuel cell stack.

### SUMMARY OF THE INVENTION

An initial driving method of a fuel cell is provided that reduces a starting time of a fuel cell stack by controlling an output voltage of the fuel cell stack to be lower than a rated voltage when starting a system. In addition, a fuel cell system is provided that is capable of promptly starting a stack without detrimentally affecting the stack, even if the membrane in the stack is dehydrated.

In an exemplary embodiment of the present invention, a fuel cell system is providing including a fuel cell stack and a starting controller. The fuel cell stack has output terminals for applying an output voltage. The starting controller is configured to control the output voltage applied across the output terminals of the fuel cell stack during a starting period to be a starting voltage lower than a rated voltage.

In one embodiment, the starting controller includes a detector configured to detect the output voltage of the fuel cell stack; a comparator configured to compare the output voltage detected from the detector and an internal control voltage and to provide an output signal; and a switching unit coupled to the output terminals of the fuel cell stack. The switching unit is in series with the detector and configured to turn on and to turn off in response to the output signal of the comparator.

In one embodiment, the output terminals of the fuel cell stack include a first output terminal and a second output terminal; and the starting controller includes a switch including a first electrode, a second electrode, and a control electrode, the first electrode being coupled to the first output terminal; a first resistance coupled between the second electrode and the second output terminal; an amplifier having an amplifier output terminal, a positive input terminal, and a negative input terminal, the amplifier output terminal being coupled to the control electrode; a second resistance coupled between the negative input terminal and the second electrode; and a control power source for providing a control voltage, the control power source being coupled between the second output terminal and the positive input terminal. The amplifier compares the control voltage with a voltage at the negative input terminal and outputs a signal for turning on and turning off the switch such that the output voltage of the fuel cell stack corresponds to the control voltage.

In one embodiment, the starting voltage is a lowest driving voltage of the fuel cell stack, the lowest driving voltage being a lowest voltage for normally operating the fuel cell stack.

In one embodiment, hydrogen is supplied to the fuel cell stack at a flow rate less than 1.2 times a stoichiometric required flow rate.

In one embodiment, the fuel cell system further includes a charge circuit unit coupled in parallel with the starting controller; and a switch for selectively connecting the fuel cell stack with the starting controller and the fuel cell stack with the charge circuit unit.

In one embodiment, the charge circuit unit includes an auxiliary power source coupled to the fuel cell stack; a charge circuit configured to charge the auxiliary power source with output power of the fuel cell stack; and a charge control circuit configured to control the charge circuit.

In one embodiment, the fuel cell system further includes a reactant supply for supplying a fuel or an oxidant; and a second auxiliary power source for supplying power to the reactant supply during the starting period.

In one embodiment, the starting controller includes a control power source for providing a control voltage and the starting controller operates such that a ratio between the output voltage of the fuel cell stack and the control voltage is within the range of 5:3 to 7:2.

In one embodiment, the fuel cell stack is a proton exchange membrane fuel cell or in a direct liquid fuel cell.

In one embodiment, the fuel cell stack is an air breathing fuel cell.

In an exemplary embodiment of the present invention, an initial driving method of a fuel cell is provided. The fuel cell includes a fuel cell stack and a starting controller coupled to the fuel cell stack. The fuel cell stack has output terminals for applying an output voltage. The method includes starting the fuel cell stack by supplying fuel; and controlling the output voltage applied across the output terminals during a starting period to be a starting voltage lower than a rated voltage.

In one embodiment, the starting voltage is a lowest driving voltage of the fuel cell stack, the lowest driving voltage being a lowest voltage for normally operating the fuel cell stack.

In one embodiment, the method further includes lowering a flow rate of hydrogen supplied to the fuel cell stack to be less than a stoichiometric required flow rate.

In one embodiment, the method further includes supplying output power of the fuel cell stack controlled by the starting voltage to a balance of plant electrically coupled to the fuel cell stack.

In one embodiment, the method further includes supplying output power of the fuel cell stack controlled by the starting voltage to a charge controller electrically coupled to the fuel cell stack.

In one embodiment, the starting controller includes a control power source for providing a control voltage, and when controlling the output voltage, the starting controller operates such that a ratio between the output voltage and the control voltage is within the range of 5:3 to 7:2.

In one embodiment, the fuel cell stack is an air breathing fuel cell.

In an exemplary embodiment of the present invention, an initial driving method of a fuel cell is provided. The fuel cell includes a fuel cell stack and a starting controller coupled to the fuel cell stack. The fuel cell stack has output terminals for applying an output voltage. The method includes detecting the output voltage; comparing the detected output voltage with an internal control voltage; and when the internal control voltage is less than the detected output voltage, controlling the output voltage during a starting period to be a starting voltage lower than a rated voltage, the starting voltage being a lowest driving voltage of the fuel cell stack, the lowest driving voltage being greater than a lowest voltage for normally operating the fuel cell stack.

### BRIEF DESCRIPTION OF THE DRAWINGS

These and/or other embodiments and features of the invention will become apparent and more readily appreciated from the following description of certain exemplary embodiments, taken in conjunction with the accompanying drawing of which:

FIG. 1 is a schematic view of a fuel cell system according to a first embodiment of the present invention;

FIG. 2 is a circuit view adoptable into a main portion of the fuel cell system of FIG. 1;

FIG. 3 is a graph showing a starting condition of a fuel cell system according to the present invention;

FIG. 4 is a flow chart for an initial driving method of a fuel cell according to the present invention;

FIG. 5 is a graph showing a starting condition of a fuel cell system according to the present invention;

FIG. 6 is a schematic view of a fuel cell system according to a second embodiment of the present invention; and

FIG. 7 is a graph showing an operation principle of the fuel cell system of FIG. 6.

### DETAILED DESCRIPTION

Hereinafter, certain exemplary embodiments according to the present invention will be described with reference to the accompanying drawings. Herein, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

FIG. 1 is a schematic view of a fuel cell system 10 according to a first embodiment of the present invention. The fuel cell system 10 includes a fuel cell stack 20 and a starting controller 30. The starting controller 30 keeps an output voltage of the fuel cell stack 20 at a voltage (hereinafter, referred to as a starting voltage) that is lower than a rated voltage during a starting period of the system. Herein, the rated voltage may be a voltage determined by subtracting a voltage loss inside the stack from a voltage obtained by multiplying the number of cells by a proper voltage per cell when manufacturing the fuel cell stack 20. The voltage loss inside the stack may be due to a kinetic loss, an ohmic loss, or a mass transport loss.

The fuel cell stack includes one or more unit cells arranged in a stacked configuration. Each unit cell includes a membrane electrode assembly (MEA) having an anode, a cathode, and an electrolyte positioned between the anode and the cathode. The fuel cell stack produces electric energy through an electrochemical reaction between the fuel supplied to the anode and the oxidant supplied to the cathode. The anode can include an anode electrode and an anode separator having a flow passage for supplying fuel to the anode electrode, and the cathode can include a cathode electrode and a cathode separator having a flow passage or a hole for supplying fuel to the cathode electrode.

In exemplary embodiments, the fuel cell stack 20 is a proton exchange membrane fuel cell or a direct liquid fuel cell. In one embodiment, the fuel cell stack 20 is an air breathing fuel cell. The air breathing fuel cell has a structure in which a cathode electrode is exposed to the atmosphere and ambient air is supplied to the cathode electrode by natural convection.

When the fuel cell stack 20 is an air breathing fuel cell which has not been used for a long time, on start-up, the membrane of the fuel cell stack 20 is commonly in a dehydrated state such that it takes a long time for the output of the stack 20 to be stabilized. However, according to an exemplary embodiment of the present invention, an operating voltage is lowered and operated temporarily when starting the system until the stack in a dehydrated state is stabilized using water generated from the cathode itself. More specifically, an exemplary embodiment of the present invention first hydrates the membrane electrode assembly in an initial starting of the stack 20 and then performs a starting process, thus making it possible to safely and promptly start the fuel cell stack 20.

Furthermore, if the hydrogen flow supplied to the fuel cell stack 20 is reduced to a flow rate suitable for the hydration degree of the membrane electrode assembly, by keeping the output voltage of the fuel cell stack 20 low when starting the system, the hydration of the membrane electrode assembly of the stack 20 can be more promptly processed. Therefore, it provides for a safe and prompt start-up. For example, in an exemplary embodiment, the hydrogen flow is set to be lower than 1.2 times of the stoichiometric required flow required in a normal operation of the stack 20.

The starting controller 30 is electrically connected to the output terminal of the fuel cell stack 20. The starting controller 30 is implemented as an apparatus capable of lowering the output voltage of the fuel cell stack 20 to a constant voltage lower than a rated voltage or an inconstant voltage lower than the rated voltage when starting the system. For example, the starting controller 30 can be implemented as an apparatus having the output voltage similar to a DC electronic load connected to the output terminal of the fuel cell stack 20 or an output power controlling function, for the output performance evaluation of the fuel cell stack 20.

The fuel cell system 10 of the present invention can additionally include a switching means for connecting the starting controller 30 to the fuel cell stack 20 in a starting operation mode, and for connecting an external load to the fuel cell stack 20 in a normal operation mode. The fuel cell system 10 can additionally include a reactant supply for supplying fuel and/or oxidant to the fuel cell stack 20. Furthermore, the fuel cell system 10 can additionally include an auxiliary power source such as a secondary cell for supplying power to the reactant supply and/or the external load, a converter for converting the power of the fuel cell stack and/or auxiliary power source and for transporting the power to the external load, or a control apparatus for controlling the operation of the fuel cell system 10.

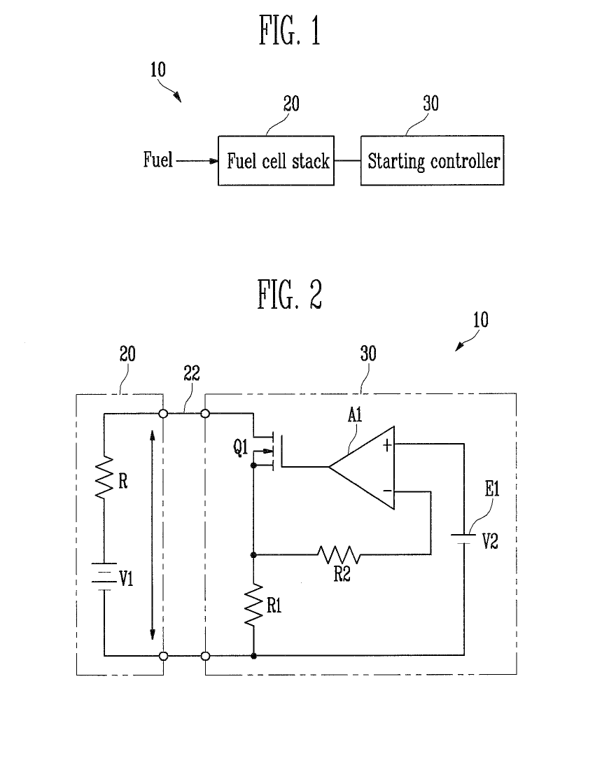

FIG. 2 is a circuit view for a main portion of a system adoptable into the fuel cell system of FIG. 1. Referring to FIG. 2, two output terminals of the fuel cell stack 20 are connected to the starting controller 30 through a cable 22. The fuel cell stack 20 includes a predetermined inner resistance R, wherein the voltage across the output terminals is set to be V1. The starting controller 30 includes a switch Q1, an amplifier A1, a control power source E1, a first resistance R1, and a second resistance R2. The switch Q1 can be implemented as a field effect transistor (FET).

The switch Q1 includes a first electrode, a second electrode, and a control electrode, wherein the first electrode is connected to a first output terminal of the fuel cell stack 20. The amplifier A1 includes a positive input terminal, a negative input terminal, and a output terminal, wherein the output terminal is connected to the control electrode of the switch Q1. One end of the first resistance R1 is connected to a second output terminal of the fuel cell stack 20 and the other end is connected to the second electrode of the switch Q1. One end of the control power source E1 is connected to the positive input terminal of the amplifier A1 and the other end is connected to the first resistance R1 and to the second output terminal of the fuel cell stack 20.

In the fuel cell system 10, the control voltage V2 of the control power source E1 and the voltage applied across the first resistance R1 are compared by means of a differential amplifier A1, and the switch Q1 is driven by means of the output voltage of the differential amplifier A1. If the control voltage V2 is set to be lower than the output voltage V1 of the fuel cell stack 20, the output voltage of the fuel cell stack 20 lowers to the same voltage as the control voltage V2.

The depicted circuit in the starting controller 30 is but one example and the present invention is not limited thereto. That is, the starting controller 30 may include any circuit known in the art for implementing a detector/sensor for detecting the output voltage V1 of the fuel cell stack 20; a comparator for comparing the output voltage detected from the detector and the internal control voltage; and a switching unit for connecting to the output terminals of the fuel cell stack, the switching unit being in series with the detector, and turning on and off by responding to the output signal of the comparator. Herein, the detector corresponds to the first resistance R1 and the comparator corresponds to the amplifier A1. Further, the voltage applied to the first resistance R1 corresponds to the output voltage of the fuel cell stack 20, ignoring the voltage drop through the switch Q1.

FIG. 3 is a graph showing a starting condition of a fuel cell system according to a first embodiment of the present invention and shows a cell voltage of a fuel cell stack with passage of time when starting a system. As shown in FIG. 3, the starting controller keeps the operating voltage V2 at about 0.25 V/cell, which is lower than the rated voltage V1 at about 0.62V/cell. The starting controller maintains the operating voltage V2 as a starting condition of the stack for a period from a starting point to time ti when starting the fuel cell system according to an exemplary embodiment of the present invention.

In an exemplary embodiment of the present invention, the output voltage of the fuel cell stack is set to be more than a lowest driving voltage capable of normally starting the stack 20, which is lower than the rated voltage V1 preset for the stack 20. The stack 20 can suddenly stop the operation thereof when one or more cells are applied with an inverse voltage due to various reasons inside the stack 20, for example, a temporary supply shortage of fuel and/or oxidant. The lowest driving voltage refers to a lowest voltage for normally operating the stack. Herein, the lowest driving voltage is assumed to be 0.2V/cell. Such a lowest driving voltage is primarily obtained based on a theoretical voltage which can be obtained by means of an electrochemical reaction in a cathode electrode, and it can be slightly varied depending on factors such as the materials of which the catalyst layers of the anode electrode and the cathode electrode are made; the fuel and/or oxidant used, and the contact resistance between the anode electrode and the cathode electrode and the separator contacting them.

If the output voltage of the stack drops below the lowest driving voltage when starting the system, it may cause a problem in starting of the system. Therefore, in an exemplary embodiment, the starting controller 30 controls the starting of the system in order that the output voltage of the stack 20 is not lower than the lowest driving voltage. In order to speed up the starting time, in an exemplary embodiment of the present invention, the starting controller 30 maintains the output voltage of the stack 20 at a slightly higher driving voltage than the lowest driving voltage from the lowest voltage. For example, when the rated voltage of the fuel cell stack 20 is within the range of 0.5V/cell to 0.7V/cell and the lowest driving voltage is 0.2V/cell, the starting controller 30 can control the voltage applied across the output terminals of the stack 20 to be in the range of 0.2V/cell to 0.3V/cell. In this case, the starting time of the system can be more effectively reduced.

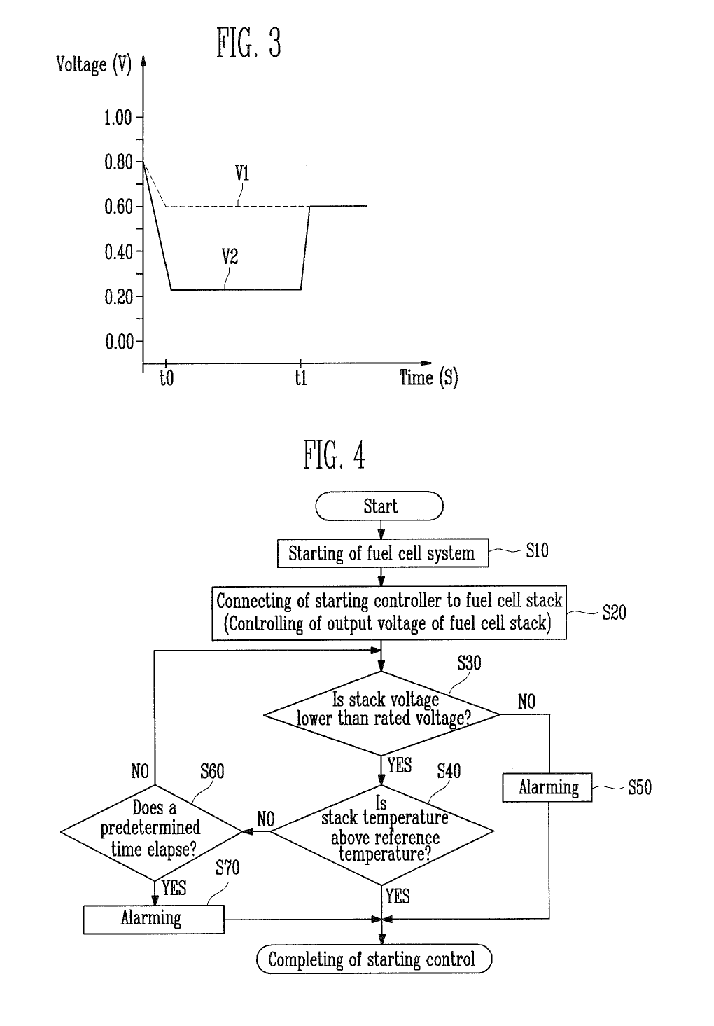

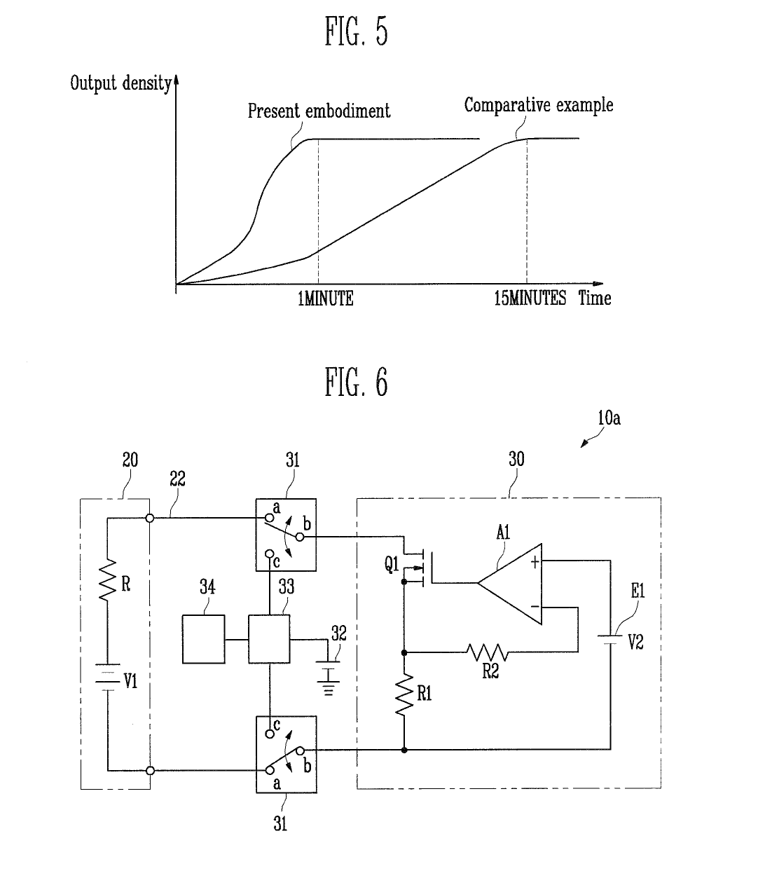

FIG. 4 is a flow chart for an initial driving method of a fuel cell system according to the present invention. Referring to FIGS. 1 to 4, the operation process of the fuel cell system will be described. First, a fuel cell system 10 is started by supplying fuel and/or oxidant to a fuel cell stack 20 (S10). The fuel cell system 10 can be started by means of an externally supplied or internally generated starting request signal. That is, the starting request signal can be a signal externally generated by means of an user's operation such as an operation signal, or can be a signal internally generated by the system controller such as a signal by means of a starting pre-setting or a timer. In an exemplary embodiment, the system controller includes a logic circuit using a microprocessor or a flip-flop.

Next, a starting controller 30 is connected to the fuel cell stack 20. The starting controller 30 controls the output voltage of the fuel cell stack 20 to a starting voltage lower than a rated voltage (S20). In step S20, the output voltage of the fuel cell stack 20 is kept lower than the rated voltage when starting the system, making it possible to hydrate a membrane electrode assembly by using water generated from the cathode of the stack 20 itself in the initial start. By hydrating the membrane electrode assembly, damage to the membrane electrode assembly by operating in a dehydrated state at a rated voltage higher than the starting voltage in the initial start can be prevented.

In order to more effectively perform the prompt and safe starting of the system, together with step S20, the present invention can set the hydrogen flow as fuel supplied to the fuel cell stack 20 to be lower than the flow required in a normal operation.

Thereafter, the starting controller 30 can judge whether a stack temperature is above a reference temperature in a state where the output voltage of the stack 20 is kept lower than the rated voltage and can thus complete the starting control process (S30 and S40). The reference temperature may be varied depending on the type or structure of the stack 20. In the case of an air breathing fuel cell, the reference temperature can be approximately set in the range of 50° C. to 70° C. If the stack voltage is not kept to be lower than the rated voltage in step S30 or the stack temperature does not reach the reference temperature after a predetermined time elapses from the stack starting time in step S60, the starting controller 30 judges that the starting control process cannot be performed and can thus send out an alarm indicating a stack malfunction or a system malfunction (S50 and S70).

FIG. 5 is a graph showing comparative experimental results for starting characteristics of a fuel cell system according to the present invention. Referring to FIG. 5, in an exemplary embodiment of the present invention a starting operation voltage of a stack is maintained at 0.2V/cell and hydrogen is supplied to an air breathing fuel cell at 1.2 times a stoichiometric flow. In the comparative example, the starting operation voltage of the stack is at 0.6V in a state where the same hydrogen flow is supplied to the same air breathing fuel cell. As can be appreciated from the experimental results, the fuel cell system according to an exemplary embodiment of the present invention has a starting time of about 1 minute, and the fuel cell system according to the comparative example has a starting time of about 15 minutes. As depicted in FIG. 5, it can be appreciated that the starting time of the fuel cell system according to exemplary embodiments of the present invention is greatly reduced.

Embodiments of the present invention can effectively use the electricity generated from the fuel cell stack when starting the system. For example, by using the electricity generated from the fuel cell stack when starting the system, embodiments of the present invention can charge an auxiliary power source in the system or supply electric energy to an another apparatus coupled to the fuel cell stack, such as, for example, the balance of plant (BOP).

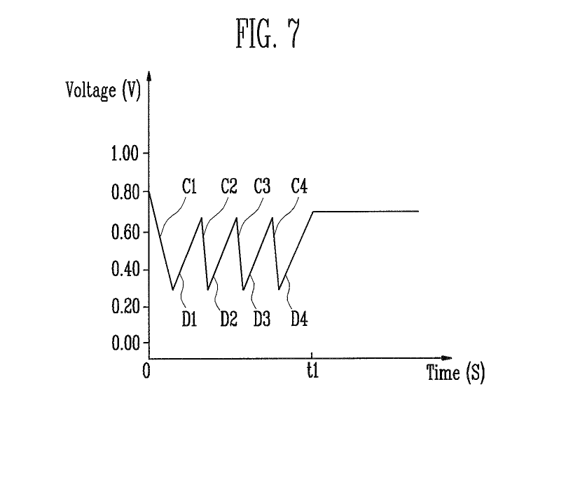

FIG. 6 is a schematic view of a fuel cell system according to a second exemplary embodiment of the present invention. Referring to FIG. 6, a fuel cell system 10a includes a fuel cell stack 20, a starting controller 30, a switching means 31 for converting a single start mode and a charge start mode of the system, and a charge circuit unit. The charge circuit unit includes an auxiliary power source 32, a charge circuit 33 charging the auxiliary power source 32, and a charge control circuit 34 controlling the charge circuit 33.

In order to promptly start the fuel cell stack 20, the fuel cell system 10a of the present embodiment maintains the output voltage of the fuel cell stack 20 at a voltage lower than a rated voltage during a starting period of the system. Also, the electric energy generated from the fuel cell stack 20 is charged to the auxiliary power source 32 during the starting period thereof.

The switching means 31 operates so that the output terminal of the stack 20 is selectively connected to the starting controller 30 or the charge circuit 33 when starting the system. The switching means 31 can be implemented as a mechanical switch having a contact or a semiconductor switch in a non-contact manner. The switching means 31 can be controlled by a control apparatus that controls the fuel cell system entirely or by the charge control circuit 34, which controls the charge circuit 33. The relation of the connection and/or the operation between the switching means 31 and the control apparatus is obvious for those skilled in the art so that the description thereof will be omitted.

The auxiliary power source 32 can be charged by the electric energy generated from the fuel cell stack 20 when starting the system. After the starting of the system is completed, the auxiliary power source 32 can supply power to a load in accordance with the request of the external and/or internal load connected to the stack 20 such as a motor, a notebook computer, a cellular phone, and a BOP.

Also, the auxiliary power source 32 can form a pair with another auxiliary power source. In such an embodiment, another auxiliary power source different from the auxiliary power source 32 can be disposed such that any one of the auxiliary power sources can be charged depending on their charge condition when starting the system. In such an embodiment, the auxiliary power source charged by the fuel cell stack 20 is the auxiliary power source 32 as shown in FIG. 6a, and the other auxiliary power source supplies power to the load. The auxiliary power sources can be implemented as a supercapacitor, a secondary cell, or the combination thereof.

The BOP includes an apparatus for supplying fuel to the anode of the fuel cell stack 20 when operating the system. Also, the BOP can include an apparatus for supplying an oxidant to the cathode thereof. In addition, in order to improve the efficiency of the system, the BOP can further include a cycling apparatus for recycling unreacted fuel or a separate apparatus for managing water or heat of the fuel cell system 10a. The BOP can be implemented as a control apparatus for controlling the fuel cell system and a reactant supply. The reactant supply supplies fuel and/or oxidant. The reactant supply can include an apparatus for supplying fuel and/or oxidant at a constant pressure or at a predetermined pressure with controlled flow. As the BOP, a pump, a fan, or a valve can be used.

The charge circuit 33 is an apparatus for charging the auxiliary power source 32 using the electric energy generated from the fuel cell stack 20. The output voltage of the stack 20 when starting the fuel cell system is lower than the rated voltage in a normal operation thereof. Therefore, the charge circuit 33 is configured to enable charging the auxiliary power source 32 with the output of the stack 20 as the output voltage of the stack 20 varies depending on the time at which the fuel cell system is started and when normally operating thereof. The charge control circuit 34 controls the operation of the charge circuit 33.

The operation process of the fuel cell system 10a according to the present embodiment will be described. First, the control apparatus coupled to the fuel cell system connects a node a of the switching means 31 to a node b thereof, when starting the system, to connect the output terminal of the fuel cell stack 20 to the starting controller 30. The starting controller 30 lowers the voltage applied across the output terminals of the stack 20 to a predetermined starting voltage lower than the rated voltage, as shown in FIG. 7 with reference numeral C1.

Thereafter, the control apparatus connects the node a of the switching means 31 to a node c thereof, when the output voltage of the stack 20 reaches a desired low voltage, to connect the output terminal of the fuel cell stack 20 to the charge circuit 33. The auxiliary power source 32 connected to the charge circuit 33 is charged by means of the electric energy of the fuel cell stack 20, and the output voltage of the fuel cell stack 20 gradually increases from a predetermined low starting voltage to a predetermined voltage, as shown in FIG. 7 with reference numeral D1.

Next, the control apparatus connects node b alternately with node a and node c such that a voltage is maintained between the starting voltage and the rated voltage, as shown FIG. 7 with reference numerals C2, D2, C3, D3, C4, and D4. According to the aforementioned process, the average output voltage of the stack 20 is lower than the rated voltage when starting the system.

With the present embodiment, when starting the fuel cell system 10a, the auxiliary power source 32 can be charged with the output voltage of the stack 20, while lowering the output voltage of the stack 20 to a voltage lower than the rated voltage.

The present invention is exemplarily applied to the air breathing fuel cell system, but the present invention is not limited thereto. For example, the present invention can be applied to a system including a fuel cell stack of which cathode electrode is not exposed to the atmosphere. In other words, the present invention can promptly and safely start the stack without damaging the membrane electrode assembly when the membrane is dehydrated. As discussed above, the membrane may be dehydrated in air breathing fuel cells when the stack is unused for a long time.

With embodiments of the present invention, when starting the system, the output voltage of the fuel cell stack is controlled to be maintained at a voltage lower than the rated voltage, making it possible to greatly reduce the system starting time. Furthermore, embodiments of the present invention can promptly and safely start the stack without damaging a membrane in the stack that is dehydrated due to the stack being unused for a long time.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A fuel cell system comprising:
a fuel cell stack having output terminals for applying an output voltage; and
a starting controller configured to control the output voltage applied across the output terminals of the fuel cell stack during a starting period to be a starting voltage lower than a rated voltage.

2. The fuel cell system as claimed in claim 1, wherein the starting controller comprises:
a detector configured to detect the output voltage of the fuel cell stack;
a comparator configured to compare the output voltage detected from the detector and an internal control voltage and to provide an output signal; and
a switching unit coupled to the output terminals of the fuel cell stack, the switching unit being in series with the detector and configured to turn on and to turn off in response to the output signal of the comparator.

3. The fuel cell system as claimed in claim 1, wherein:
the output terminals of the fuel cell stack include a first output terminal and a second output terminal; and
the starting controller comprises:
a switch including a first electrode, a second electrode, and a control electrode, the first electrode being coupled to the first output terminal;
a first resistance coupled between the second electrode and the second output terminal;
an amplifier having an amplifier output terminal, a positive input terminal, and a negative input terminal, the amplifier output terminal being coupled to the control electrode;
a second resistance coupled between the negative input terminal and the second electrode; and
a control power source for providing a control voltage, the control power source being coupled between the second output terminal and the positive input terminal,
wherein the amplifier compares the control voltage with a voltage at the negative input terminal and outputs a signal for turning on and turning off the switch such that the output voltage of the fuel cell stack corresponds to the control voltage.

4. The fuel cell system as claimed in claim 1, wherein the starting voltage is a lowest driving voltage of the fuel cell stack, the lowest driving voltage being a lowest voltage for normally operating the fuel cell stack.

5. The fuel cell system as claimed in claim 1, wherein hydrogen is supplied to the fuel cell stack at a flow rate less than 1.2 times a stoichiometric required flow rate.

6. The fuel cell system as claimed in claim 1, further comprising:
a charge circuit unit coupled in parallel with the starting controller; and
a switch for selectively connecting the fuel cell stack with the starting controller and the fuel cell stack with the charge circuit unit.

7. The fuel cell system as claimed in claim 6, wherein the charge circuit unit comprises:
an auxiliary power source coupled to the fuel cell stack;
a charge circuit configured to charge the auxiliary power source with output power of the fuel cell stack; and
a charge control circuit configured to control the charge circuit.

8. The fuel cell system as claimed in claim 7, further comprising:
a reactant supply for supplying a fuel or an oxidant; and
a second auxiliary power source for supplying power to the reactant supply during the starting period.

9. The fuel cell system as claimed in claim 1, wherein the starting controller includes a control power source for providing a control voltage and the starting controller operates such that a ratio between the output voltage of the fuel cell stack and the control voltage is within the range of 5:3 to 7:2.

10. The fuel cell system as claimed in claim 1, wherein the fuel cell stack is a proton exchange membrane fuel cell or in a direct liquid fuel cell.

11. The fuel cell system as claimed in claim 10, wherein the fuel cell stack is an air breathing fuel cell.

12. An initial driving method of a fuel cell including a fuel cell stack and a starting controller coupled to the fuel cell stack, the fuel cell stack having output terminals for applying an output voltage, the method comprising:
starting the fuel cell stack by supplying fuel; and
controlling the output voltage applied across the output terminals during a starting period to be a starting voltage lower than a rated voltage.

13. The initial driving method of the fuel cell as claimed in claim 12, wherein the starting voltage is a lowest driving voltage of the fuel cell stack, the lowest driving voltage being a lowest voltage for normally operating the fuel cell stack.

14. The initial driving method of the fuel cell as claimed in claim 12, further comprising:
lowering a flow rate of hydrogen supplied to the fuel cell stack to be less than a stoichiometric required flow rate.

15. The initial driving method of the fuel cell as claimed in claim 12, further comprising:
supplying output power of the fuel cell stack controlled by the starting voltage to a balance of plant electrically coupled to the fuel cell stack.

16. The initial driving method of the fuel cell as claimed in claim 12, further comprising:
supplying output power of the fuel cell stack controlled by the starting voltage to a charge controller electrically coupled to the fuel cell stack.

17. The initial driving method of the fuel cell as claimed in claim 12, wherein the starting controller includes a control power source for providing a control voltage, and when controlling the output voltage, the starting controller operates such that a ratio between the output voltage and the control voltage is within the range of 5:3 to 7:2.

18. The initial driving method of the fuel cell as claimed in claim 12, wherein the fuel cell stack is an air breathing fuel cell.

19. An initial driving method of a fuel cell, the fuel cell including a fuel cell stack and a starting controller coupled to the fuel cell stack, the fuel cell stack having output terminals for applying an output voltage, the method comprising:
detecting the output voltage;
comparing the detected output voltage with an internal control voltage; and
when the internal control voltage is less than the detected output voltage, controlling the output voltage during a starting period to be a starting voltage lower than a rated voltage, the starting voltage being greater than a lowest driving voltage of the fuel cell stack, the lowest driving voltage being a lowest voltage for normally operating the fuel cell stack.
